(19) United States
(12) Patent Application Publication
(10) Pub. No.: US 2023/0394820 A1
(43) Pub. Date: Dec. 7, 2023

(54) METHOD AND SYSTEM FOR ANNOTATING VIDEO SCENES IN VIDEO DATA

(71) Applicant: Denis Kutylov, Celebration, FL (US)

(72) Inventor: Denis Kutylov, Celebration, FL (US)

(21) Appl. No.: 18/454,853

(22) Filed: Aug. 24, 2023

(51) Int. Cl. G06V 20/20; G06V 20/40; G06V 10/56; G06V 10/54; G06V 10/82; G06V 10/50; G06F 40/40; G06F 16/783; G06F 16/11

(52) U.S. Cl. CPC G06V 20/20; G06V 20/49; G06V 20/46; G06V 10/56; G06V 10/54; G06V 10/82; G06V 20/41; G06V 10/50; G06F 40/40; G06F 16/783; G06F 16/116; G06V 2201/10

(57) ABSTRACT

This invention relates to the field of video annotation, summarization and video indexing. A method for annotating video scenes in video data, executed by at least one processor, the method comprising steps of receiving video data, dividing video data into scenes sequentially, starting from the first video frame, selecting scene keyframes for each scene, selecting a main keyframe for each scene from previously selected scene keyframes basing on the following parameters: mean variability per video frame pixel, contrast, color gamut, annotating all keyframes of each scene.

### FIELD OF THE INVENTION

This invention relates to the field of video annotation, summarization and video indexing.

### BACKGROUND

Identifying content within a video can help to determine the portions of the video relevant to a user's task. When searching for a scene in known systems, a user may input a search word to search for a desired scene. However, identifying the content is often difficult when relying on summaries of the videos that may only reference an individual aspect of the video. Existing methods are insufficient to reliably identify relevant video segments due to a lack of context in video searching.

A system and method for generating a synopsis video from a source video described in U.S. Pat. No. 8,818,038 (BriefCam Ltd). In a system and method for generating a synopsis video from a source video, at least three different source objects are selected according to one or more defined constraints, each source object being a connected subset of image points from at least three different frames of the source video. One or more synopsis objects are sampled from each selected source object by temporal sampling using image points derived from specified time periods. For each synopsis object a respective time for starting its display in the synopsis video is determined, and for each synopsis object and each frame a respective color transformation for displaying the synopsis object may be determined. The synopsis video is displayed by displaying selected synopsis objects at their respective time and color transformation, such that in the synopsis video at least three points that each derive from different respective times in the source video are displayed simultaneously.

U.S. Pat. No. 11,544,322 B2 (University of California Adobe Inc) issued on 3 Jan. 2023 and “Facilitating contextual video searching using user interactions with interactive computing environments” discloses method and system that includes detecting control of an active content creation tool of an interactive computing system in response to a user input received at a user interface of the interactive computing system. The method also includes automatically updating a video search query based on the detected control of the active content creation tool to include context information about the active content creation tool. Further, the method includes performing a video search of video captions from a video database using the video search query and providing search results of the video search to the user interface of the interactive computing system.

### SUMMARY OF THE INVENTION

### Brief Description of the Drawings

FIG. 1 shows a diagram of the organization of a method for annotating video scenes in video data.

FIG. 2 shows sequence of annotation formation.

FIG. 3 shows one possible implementation of a computer system in accordance with some embodiments of the present invention.

FIG. 4 shows one possible implementation of a server present in networked computing environment in accordance with some embodiments of the present invention.

### DETAILED DESCRIPTION OF THE NON-LIMITING EMBODIMENTS

The proposed technology is aimed at improving quality of annotating video scenes in video data.

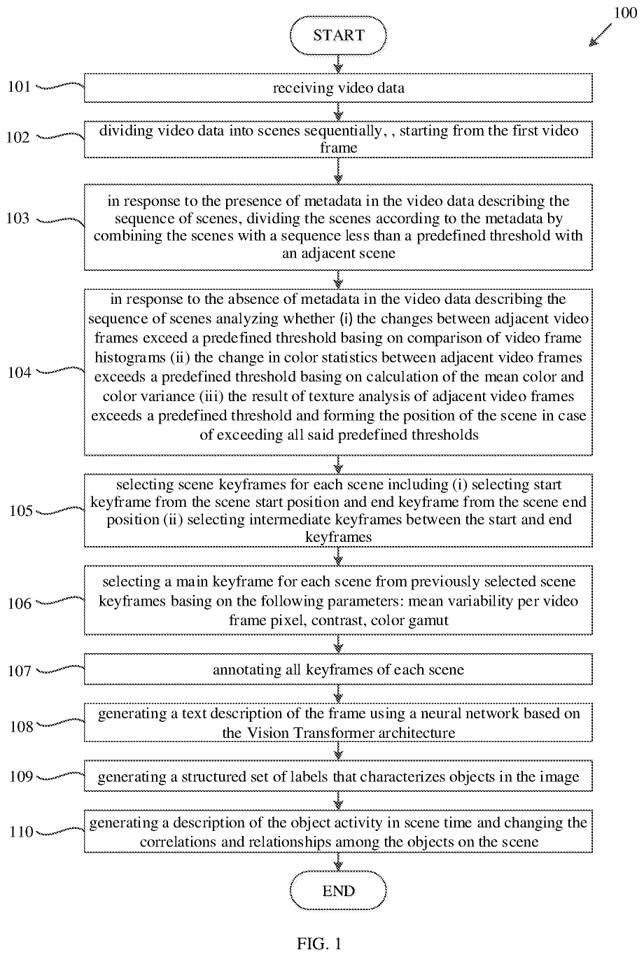

These is achieved through the proposed method for annotating video scenes in video data, comprising following steps show on FIG. 1.
receiving video data;
dividing video data into scenes sequentially, starting from the first video frame, wherein:
   in response to the presence of metadata in the video data describing the sequence of scenes, dividing the scenes according to the metadata by combining the scenes with a sequence less than a predefined threshold with an adjacent scene;
   in response to the absence of metadata in the video data describing the sequence of scenes:
      analyzing whether the changes between adjacent video frames exceed a predefined threshold basing on comparison of video frame histograms;
      analyzing whether the change in color statistics between adjacent video frames exceeds a predefined threshold basing on calculation of the mean color and color variance;
      analyzing whether the result of texture analysis of adjacent video frames exceeds a predefined threshold;
      in response to exceeding all said predefined thresholds, forming the position of the scene;
selecting scene keyframes for each scene, wherein
   selecting start keyframe from the scene start position and end keyframe from the scene end position;
   selecting intermediate keyframes between the start and end keyframes;
selecting a main keyframe for each scene from previously selected scene keyframes basing on the following parameters: mean variability per video frame pixel, contrast, color gamut; annotating all keyframes of each scene, wherein:
   generating a text description of the frame using a neural network based on the Vision Transformer architecture;
   generating a structured set of labels that characterizes objects in the image;
   generating a description of the object activity in scene time and changing the correlations and relationships among the objects on the scene.

Video data is a sequence of video frames. In some embodiments, the video data includes metadata.

A video frame is a piece of video containing an image and metadata corresponding to said video frame.

A method for annotating video scenes in video data, executed by at least one processor, comprising the following steps:

Receiving Video Data

In some embodiments, the video data may be received as user-provided files for annotation.

In some embodiments, the video data may be a set of video files related to a single video clip, video film.

In some embodiments, the video data may be provided as videostreaming.

In some embodiments, the video data may be received from external video sources, such as a video capture card, video camera, etc.

Dividing Video Data into Scenes

The received video data is divided into scenes sequentially, wherein in some cases the division into scenes may be performed in advance and be available as metadata in the video data.

Metadata describing the sequence of scenes can be contained in, but not limited to, video files of common formats such as MP4, AVI, MKV, QuickTime. Scene sequence information includes time, scene name (optional).

This data is generated in video editors, as well as when shooting with a camera.

Some examples of cameras that can store scene sequence metadata are:

Professional Cameras: Most professional cameras used in the film and television industry can store filming time metadata. This may include cameras such as the Sony PMW-F5 and ARRI ALEXA.

Reflex cameras for video filming: Some reflex cameras that are also capable of shooting video, such as the Canon EOS 5D Mark IV and Panasonic Lumix GH5, can also save filming time metadata.

Action Cameras: Some action cameras, such as the GoPro HERO7 and DJI Osmo Action, can also save filming time metadata.

In some embodiments, timestamps are read from a sequence of scenes in metadata and used directly to receive scene intervals in the video data.

In the case where there is no metadata containing a sequence of scenes in the video data, the video data is sequentially divided into scenes. The division into a sequence of scenes is performed as follows:
analyzing whether the changes between adjacent video frames exceed a predefined threshold (threshold_1) basing on comparison of video frame histograms;
analyzing whether the change in color statistics between adjacent video frames exceeds a predefined threshold (threshold_2) basing on calculation of the mean color and color variance;
analyzing whether the result of texture analysis of adjacent video frames exceeds a predefined threshold (threshold_3)
if each of said thresholds is exceeded as a result of the analysis, then the current video frame is considered the end of the current scene, and the adjacent video frame is considered the start of a new scene.

In some embodiments, the received intervals (positions) of the scenes are stored with reference to video data. In some embodiments, a video fragment and information about the interval time and its position in the video are stored. For example, the following record (tuple) may be stored in the database: <Scene ID, scene start time, scene end time, video frames related to the scene> or <Link to a video file or other file ID, Scene ID, scene start time, scene end time> or <Link to video file or other file ID, Scene ID, scene start time, scene duration>. It is obvious for those skilled in the art that the sequence of fields (attributes) in the record (tuple) may vary or be a combination of the above examples.

In some embodiments, the predefined thresholds: threshold_1, threshold_2, threshold_3 are set by the user.

In some embodiments, the predefined thresholds: threshold_1, threshold_2, threshold_3 are experimentally defined or dynamically selected basing on statistics or artificial intelligence algorithms.

In some embodiments, threshold_1 and/or threshold_2 and/or threshold_3 are set in the range of [0.6 . . . 0.8].

In some embodiments, analysis of the change between adjacent video frames based on comparison of video frame histograms is performed as follows:
the histogram of the first video frame is taken as a reference;
the histograms of the reference video frame and the next video frame are compared;
if the difference between the color histograms exceeds the predefined threshold (threshold_1), then the current frame is considered the start of a new scene;
the histogram of the current video frame becomes the reference histogram.

The above steps are looped until the end of the available video frames in the video data.

In some embodiments, the analysis of the change in color statistics between adjacent video frames is performed as follows:
The mean color of the video frame is defined (calculated).
The variance of the video frame is defined; The values of mean color of the pixel and variance are selected as reference for the first video frame;
The values of mean color and variance of the reference video frame and the next video frame are compared;
If the difference between the mean color or the variance exceeds the predefined threshold (threshold_2), then the current video frame is considered the start of a new scene;

In some embodiments, the mean color is defined (calculated) as follows:
Calculations in any color model (e.g. RGB or HSV) are possible. If the RGB model is selected, the R, G, and B color component values are received for each pixel of the video frame.
Then, the arithmetic mean of the color components of all pixels in the video frame is calculated.
Optionally, the received value is normalized (0 . . . 1).

For example, if there is a pixel with R=200, G=100, and B=50 color components, we can normalize the values by dividing each component by 255 (for the RGB model):

R_norm=200/255≈0.7843

G_norm=100/255≈0.3922

B_norm=50/255≈0.1961

Mean color=(0.7843+0.3922+0.1961)/3≈0.4575

In some embodiments, the change in color statistics between adjacent video frames is analyzed as follows:
The dominant color of the video frame is defined (calculated);
The variance of the video frame is defined;
The values of the dominant color and variance is selected as reference for the first video frame;
The values of dominant color and variance of the reference video frame and the next video frame are compared;
If the difference between the dominant color or the variance exceeds the predefined threshold (threshold_2), then the current video frame is considered the start of a new scene;
The histogram of the current video frame becomes the reference histogram.

In some embodiments, the video frame variance is defined as follows:
The video frame (video frame image) is converted to RGB or HSV format (any color model can be used).
The video frame is divided into, but not limited to, blocks of a given size (AxA, for example, 4×4, 6×6, 8×8 pixels, where A is a natural number).
For each block, the mean color value is defined (for example, the mean value of the R, G, and B components).
The color variance is defined for each block using the formula:

var=(1/(n−1))*sum((xi−mean)\hat{ }2)
where n is the number of pixels in the block, xi is the color value of each pixel, mean is the mean color value for the block, sum is the sum of all block pixels.
The mean color variance is defined for the entire image by averaging the color variances of all blocks.

Suppose, there are pixels with normalized color component values:

R_norm=0.8, G_norm=0.4, B_norm=0.2

R_norm=0.7, G_norm=0.3, B_norm=0.1

R_norm=0.9, G_norm=0.5, B_norm=0.3

And the mean color can be defined as follows: Mean_color=0.4575

To calculate the variance, we can use the formula:

var=(1/(n−1))*sum((xi−mean)\hat{ }2)
where n is the number of pixels, xi are the values of the pixel color components, mean is the mean color, sum is the sum of all values in brackets.

The variance for each color component is:

var_R=(1/(3−1))*((0.8−0.4575)\hat{ }2+(0.7−0.4575)\hat{ }2+(0.9-0.4575)\hat{ }2)≈0.1859

var_G=(1/(3−1))*((0.4−0.4575)\hat{ }2+(0.3−0.4575)\hat{ }2+(0.5-0.4575)\hat{ }2)≈0.0381

var_B=(1/(3−1))*((0.2−0.4575)\hat{ }2+(0.1−0.4575)\hat{ }2+(0.3−0.4575)\hat{ }2)≈0.0381

The mean variance=(var_R+var_G+var_B)/3

The mean variance in our example is: (0.1859+0.0381+0.0381)/3=0.0874

In some embodiments, texture analysis of adjacent video frames is performed as follows:
Texture adjacency matrix matching: texture adjacency matrix is calculated for each video frame, which reflects the statistical characteristics of textures in the image;
Comparison of parameters of statistical texture distributions: for each video frame, statistical parameters of texture distributions are determined, such as mean, standard deviation, skewness coefficient and kurtosis;
Comparison of spectral characteristics of textures: the spectral characteristics of textures are calculated for each image, such as spectrum energy, spectrum mass center, and spectrum correlation coefficient.

In some embodiments, a Fourier transform is used to determine the spectral characteristics of a video frame, such as using the Fast Fourier Transform (FFT).

In some embodiments, the spectrum energy is defined as the sum of squares of the amplitudes of each element of the spectrum. This can be determined by squaring each element of the spectrum and then summing all the resulting values.
1. Calculation of the spectrum mass center: the spectrum mass center is the weighted mean of frequencies at which the spectrum components are located. It can be calculated by multiplying each frequency of the spectrum by the corresponding amplitude and then dividing the sum of all the received values by the sum of the amplitudes.
2. Calculation of the spectrum correlation coefficient: The spectrum correlation coefficient is used to measure the degree of similarity between two spectra. It can be calculated using the Pearson correlation formula, which determines the degree of linear relationship between two sets of data. The spectrum correlation coefficient can be calculated as the covariance between two spectra divided by the product of their standard deviations.

Then the characteristics of the received results of the two video frames are compared by calculating the Euclidean distance between the respective elements.

In some embodiments, some of the following tools may be used to divide video into scenes:
PySceneDetect is a console application and library for video scene recognition in Python. https://sceneddetect.com/en/latest/
FFProbe—a tool for detecting transitions between scenes. Part of the FFMpeg toolkit, a popular package of video console applications. http://trac.ffmpeg.org/wiki/FFprobeTips

In some embodiments, the order in which the video is divided into scenes can be done using the FFProbe software using the following commands:
“ffprobe-show_frames-of compact=p=0-f lavfi movie=‘VIDEO.MP4’,select=gt(scene\,0.7)”
where:
VIDEO.MP4 is the video file of interest.

0.7 is a difference threshold between adjacent frames, which defines the transition to a new scene. The lower the threshold, the smaller the amount of differences between adjacent frames will be taken as a transition to a new scene and the more scenes will be recognized. The higher the threshold, the more differences between adjacent frames will be needed to determine the transition to a new scene. 0.7 is the optimal value revealed during the experiments.

The result of the execution of the command described above will be a list of timestamps at which the scene changes occur. For example:
2.5372
4.37799
6.65301
8.09344

Thus, there is a list of video scenes. The duration of each scene can be calculated by subtracting the current timestamp from the next one: Lₛ=Tₙ₊₁−Tₙ. The duration of the last scene is calculated by subtracting the timestamp from the duration of the entire video: Lₛ=Lᵥ−Tₙ

Selecting Scene Keyframes for Each Scene

The start keyframe is selected from the scene start position and the end keyframe is selected from the scene end position. In some embodiments, the start keyframe is selected from the scene start position with an offset of at least the first predefined threshold (threshold_start_frame) from the scene duration, and the end keyframe is selected with an offset of at least the second predefined threshold (threshold_end_frame). So, for example, if the scene duration is 30 seconds, the video is 60 fps, then the start keyframe will be selected from the frames starting later than the 3rd second-181 frames, and the end one—a little earlier than 27 seconds.

Selecting intermediate keyframes between the start and end keyframes.

In some embodiments, frames are selected at a fixed intermediate interval. In some embodiments, the interval is predefined, such as, but not limited to, every 20th or every 30th frame.

In some embodiments, the intermediate interval is set dynamically basing on available computing resources. For example, if the performance of the current computer system is not high (there is little available RAM, the processor is heavily loaded or has low performance), then a larger interval is selected among the frames than originally set one.

Selecting a main keyframe for each scene from previously selected scene keyframes

In some embodiments, the main keyframe is selected basing on the following parameters: mean variability per video frame pixel, contrast, color gamut. For each keyframe, the mean variability per pixel of a video frame, contrast, and color gamut are defined. The frame that has the best performance is selected as the main one for this scene.

In some embodiments, the mean variability per pixel of a video frame is calculated as follows:
the video frame is converted to grayscale;
the standard deviation of brightness around a pixel is determined for each pixel;
the mean value of standard deviations for all image pixels is defined.

In some embodiments, a K×K (e.g., 5×5) window of pixels is used to determine the standard deviation of brightness, which is moved across the video frame and the standard deviation is determined for each pixel.

Contrast measurement: This method measures the ratio of maximum and minimum brightness in an image. The higher the ratio, the higher the contrast is. An image with a high ratio value has pronounced details and textures. For example, if there are dark objects on a light background in an image, they will have very low brightness values, while light objects on a dark background will have high brightness values. Thus, the video frame with the highest ratio value will have the most color and contrast.

In some embodiments, the contrast measurement is performed as follows:

The image is converted to shades of brightness (black and white). This is done in order to focus solely on the difference in brightness between areas of the image, and not on color information. The image is divided into blocks, for example, using a square N×N grid, where N is a natural number (for example, 5×5). The block sizes can be selected depending on the requirements or characteristics of the image.

For each block, the mean brightness is calculated by calculating the arithmetic mean of the brightness of all pixels within the block.

For each block, the contrast is calculated by calculating the standard deviation of the brightness of the pixels within the block (from the calculated mean brightness).

To receive the overall value of the image contrast, the mean value of the contrasts of all blocks is calculated. This is done by adding up all block contrasts and dividing by the total number of blocks.

The resulting mean contrast value is interpreted as a measure of the overall image contrast. The higher the value, the more contrast the image has. Conversely, a low value indicates low contrast.

Below is an example of calculating the contrast of an image (video frame) of 4 pixels:

| Pixel | Brightness |
|---|---|
| A | 20 |
| B | 30 |
| C | 10 |
| D | 40 |

Calculating the mean brightness of the block:

Mean brightness=(20+30+10+40)/4=25.

Calculating the difference between each brightness and the mean brightness:

For pixel A: Difference=20−25=−5

For pixel B: Difference=30−25=5

For pixel C: Difference=10−25=−15

For pixel D: Difference=40−25=15

Squaring the Differences:

For pixel A: Difference squared=(−5)\hat{ }2=25

For pixel B: Difference squared=5\hat{ }2=25

For pixel C: Difference squared=(−15)\hat{ }2=225

For pixel D: Difference squared=15\hat{ }2=225

Summing the Resulting Squares:

The sum of squared differences=25+25+225+225=500.

Extracting the Square Root of the Sum of Squared Differences:

Contrast=sqrt(500)≈22.36.

Thus, the contrast for this image is approximately 22.36.

For Another Image:

| Pixel | Brightness |
|---|---|
| A | 12 |
| B | 24 |
| C | 36 |
| D | 48 |

Calculating the Mean Brightness of the Block:

Mean brightness=(12+24+36+48)/4=30.

Calculating the Difference Between Each Brightness and the Mean Brightness of the Block:

For pixel A: Difference=12−30=−18

For pixel B: Difference=24−30=−6

For pixel C: Difference=36−30=6

For pixel D: Difference=48−30=18

Squaring the Differences:

For pixel A: Difference squared=(−18)\hat{ }2=324

For pixel B: Difference squared=(−6)\hat{ }2=36

For pixel C: Difference squared=6\hat{ }2=36

For pixel D: Difference squared=18\hat{ }2=324

Summing the Resulting Squares:

The sum of squared differences=324+36+36+324=720.

Extracting the Square Root of the Sum of Squared Differences:

Contrast=sqrt(720)≈26.83.

Thus, the contrast for this example is approximately 26.83.

As a result, the second image is more contrast than the first one.

Color gamut measurement: This method measures the number of colors in an image. The more colors, the higher the color gamut is. The higher the number of colors in an image's color gamut, the richer and brighter the image will appear. For example, it could be a nature image, where each element in the image has its own unique color and texture.

Thus, the video frame with the most colors will be more saturated and appear richer in shades of brightness.

To get the number of colors in an image, we iterate over each pixel and collect a sequence of unique color component values (RGB or HSV).

Then, having counted the total number of colors, we compare it with another image of the video frame of the scene. Since the frames are roughly similar for the same scene, an image that has a richer color gamut is better suited for use as a keyframe.

Annotating all Keyframes of Each Scene

During the video frame image annotation stage, a text description of the image content is generated, and a set of tags is also formed. The text description conveys the main meaning of what is happening in the image. It may contain a brief description of the objects, their activity and interaction. A set of tags expands the description by adding details that will further improve the search accuracy.

The set of tags is formed as a sequence of words and phrases separated by a comma. Objects and properties attached to an object are sorted by their probability value. The list structure is as follows:
Object1, property1 of object1, property2 of object1, . . . propertyN of object1, Object2, property1 of object2, property2 of object2, . . . propertyN of object2, . . .

For example, the result of annotating an image might look like this:

Test Description:

young man wearing t-shirt and shorts and young woman wearing summer dress on the beach during nice sunrise, man is holding the woman's hand and reading newspaper, there is a coffee on the table.

A set of tags:
man, 30 years old, brown hair, brown beard, glasses, white t-shirt, beige shorts, woman, 30 years old, blond hair, drown eyes, smiling, pink dress, . . .

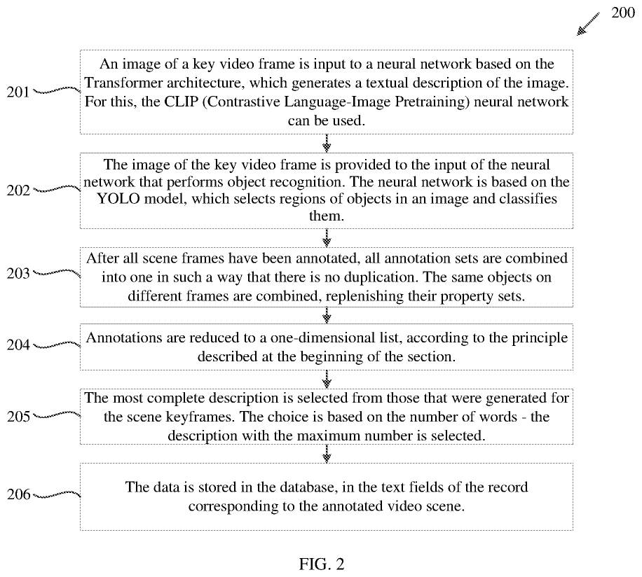

FIG. 2 shows the sequence of annotation formation is as follows:
1. An image of a key video frame is input to a neural network based on the Transformer architecture, which generates a textual description of the image. For this, the CLIP (Contrastive Language-Image Pretraining) neural network can be used.
2. In parallel, the image of the key video frame is provided to the input of the neural network that performs object recognition. The neural network is based on the YOLO model, which selects regions of objects in an image and classifies them.
   2.1. Each recognized region is cut out and the resulting fragment is transferred to the refinement recognition. Depending on its class, it is passed to the appropriate neural network or a set of networks. For example:
      2.1.1. A person
         2.1.1.1. Recognition of nationality (neural networks of classification ResNet, VGGNet, DenseNet)
         2.1.1.2. Face—recognition of facial details (neural networks RetinaFace, FaceNet)
         2.1.1.3. Face—emotion recognition (neural networks Facial Expression Recognition, DeepFace)
         2.1.1.4. Clothing—clothing type recognition (neural networks of classification ResNet, VGGNet, DenseNet)
         2.1.1.5. Color—clothing color recognition (classification neural networks ResNet, VGGNet, DenseNet)
      2.1.2. A car
         2.1.2.1. Brand recognition (classification neural networks ResNet, VGGNet, DenseNet)
         2.1.2.2. Car color recognition (classification neural networks ResNet, VGGNet, DenseNet)
      2.1.3. Transport
         2.1.3.1. Type recognition (classification neural networks ResNet, VGGNet, DenseNet)
         2.1.3.2. Brand recognition (classification neural networks ResNet, VGGNet, DenseNet)
      2.1.4. Plants, animals
         2.1.4.1. Species recognition (neural networks of classification ResNet, VGGNet, DenseNet)
      2.1.5. Logo recognition (neural networks of classification ResNet, VGGNet, DenseNet)
   2.2. The image is processed by a text recognition neural network—(Tesseract text recognition neural network)
   2.3. Classifications common for the entire image (neural networks of classification ResNet, VGGNet, DenseNet):
      2.3.1. Weather (neural networks of classification ResNet, VGGNet, DenseNet)
      2.3.2. Time of the day (neural networks of classification ResNet, VGGNet, DenseNet)
      2.3.3. Location (neural networks of classification ResNet, VGGNet, DenseNet)
   Annotations with low probability values are truncated. A threshold not lower than 0.7 is selected. Annotations are collected in a tree structure, each branch representing objects and their properties. Annotations are saved in JSON format.
3. After all scene frames have been annotated, all annotation sets are combined into one in such a way that there is no duplication. The same objects on different frames are combined, replenishing their property sets.
4. Annotations are reduced to a one-dimensional list, according to the principle described at the beginning of the section.
5. The most complete description is selected from those that were generated for the scene keyframes. The choice is based on the number of words—the description with the maximum number is selected.
6. The data is stored in the database, in the text fields of the record corresponding to the annotated video scene.

In some embodiments, object recognition and classification neural networks are trained on ready-made datasets. Example datasets are listed below.

Classification and Recognition of General Purpose Objects:
ImageNet
IFAR-10 [symbol] CIFAR-100
COCO
Openlmages
IMDB-WIKI

Classification of People:
Labeled Faces in the Wild (LFW)
CelebA
VGGFace
IMDB-WIKI
UTKFace
Adience
MORPH

Classification of Cars, Transport:
Stanford Cars Dataset
CompCars
Cars Dataset (Stanford AI Lab)
VMMRdb

Classification of Animals:
Fish Species
Caltech-UCSD Birds
Oxford Pets
iNaturalist

Classification of Plants:
PlantCLEF
Flavia
Oxford Flowers

It is also possible to work on collecting new datasets and expanding existing ones.

To optimize the training of the listed neural networks, already pre-trained neural networks are used, which were previously trained on similar datasets and made publicly available. This approach can significantly reduce the amount of training work.

The structure of the annotated video database is as follows:

Video table:

| Field | Designation |
|---|---|
| id | Video ID |
| path | Video storage path |
| duration | Video duration |

Video Scene table:

| Field | Designation |
|---|---|
| id | Scene ID |
| video_id | ID of the video that the |
| | scene belongs to |
| start | Video scene start time |
| duration | Video duration |
| description | Text description - the |
| | most complete text |
| | description of keyframe |
| | descriptions, line |
| labels | Integrated, prepared |
| | annotation set - comma |
| | separated list, line |

Video scene KeyFrames table

| Field | Designation |
|---|---|
| id | Frame ID |
| index | Frame number in the |
| | scene |
| scene_id | ID of the scene that the |
| | frame belongs to |
| is_main | Flag - The frame is the |
| | main one in the scene |
| file_name | Image file name |
| description | Text description of the |
| | frame, line |
| labels | annotation set, JSON line |

In some embodiments, to refine the annotation of objects, each individual object in the scene is selected and annotated individually, thus creating groups of annotations. For example, in some embodiments, descriptions of each person are grouped for people in the frame, including their age, hair color, emotions, clothes, etc., and an accurate classification is carried out for animals and plants using a specialized neural network described earlier.

In some embodiments, text generation based on the Transformer recurrent neural network is used to generate a description of the object activity in scene time and change the correlations and relationships among the objects in the scene. The neural network receives a convolution of the frame image, and generates a literary text description, which is added to the annotation set.

Indexing Generated Annotations

The indexing mechanism is necessary for high search performance and depends on the search engine used.

Search is limited to database data only, so when using, for example, PostgreSQL, no additional indexing steps are required, while using an ElasticSearch search engine or cloud search (such as Google Cloud Search or Amazon CloudSearch) requires enabling the search engine to index database data. This is done directly according to the rules of the selected search engine.

The main indexing object is the video scene table. Text fields with a description and a list of annotations are processed by the search engine according to its embodiment.

In some embodiments, an index is assigned to each user to delimit the visibility of video data between users.

Receiving a Custom Search Query and Performing a Search

The user enters his search query, which is transmitted to the search engine.

The system performs a full-text search in the database for the table of video scenes.

As a result of the search, the system returns a list of scene records that are relevant to the search query.

The user receives an output with images of the main keyframes of the scenes and text descriptions. In some embodiments, he can view the video fragment associated with the found frame, as well as familiarize himself with the set of annotations.

In some embodiments, after a user request has been received, an analysis is performed, including:
Processing of morphological variations.
Processing of synonyms with correct meanings.

In some embodiments, when analyzing a user request, the following is additionally performed:
Handling summaries.
Processing the conceptual set.
Knowledge base processing.
Handling inquiries and questions in plain language.

In some embodiments, a classifying neural network may be used to determine the similarity of the context of the annotation set and the context of the search query as a criterion for filtering and increasing the relevance of the output.

In some embodiments, recurrent networks and networks with one-dimensional convolution can be used to classify texts.

Some embodiments of semantic search may use known from the art solutions such as Amazon Comprehend, an NLP natural language processing service for revealing the meaning of text.

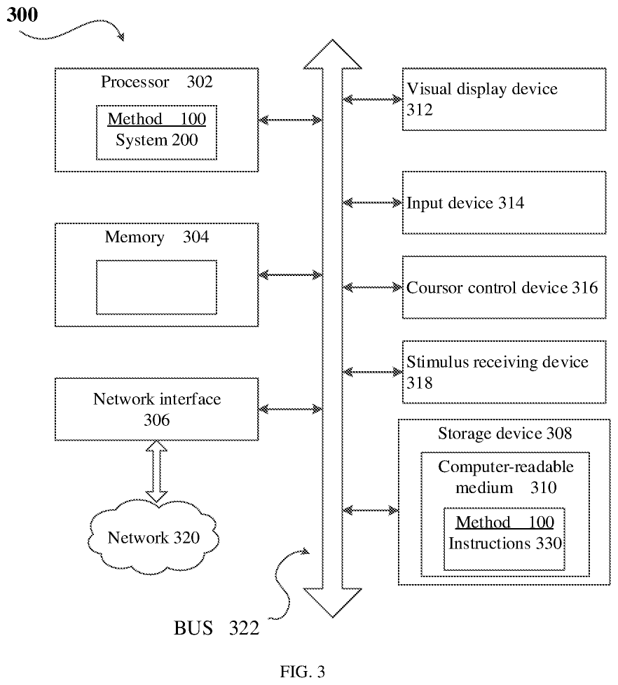

FIG. 3 shows an example of one possible implementation of a computer system 300 that can perform one or more of the methods described herein.

The computer system may be connected (e.g., over a network) to other computer systems on a local area network, an intranet, an extranet, or the Internet. The computer system may operate as a server in a client-server network environment. A computer system may be a personal computer (PC), a tablet computer, a set-top box (STB), a personal digital assistant (PDA), a mobile phone, or any device capable of executing a set of instructions (sequential or otherwise) that specifies actions to be performed by this device. In addition, while only one computer system is illustrated, the term “computer” should also be understood as any complex of computers that individually or collectively execute a set (or multiple sets) of instructions to perform any one or more of the methods described herein.

The exemplary computer system 300 consists of a data processor 302, random access memory 304 (e.g., read only memory (ROM), flash memory, dynamic random access memory (DRAM) such as synchronous dynamic random access memory (SDRAM)) and data storage devices 308 that communicate with each other via a bus 322.

The data processor 302 is one or more general purpose processing units such as a microprocessor, a central processing unit, and the like. The data processor 302 may be a full instruction set computing (CISC) microprocessor, a reduced instruction set computing (RISC) microprocessor, a very long instruction word (VLIW) microprocessor, a processor implementing other instruction sets, or a processor implementing a combination of instruction sets.

The data processor 302 may also be one or more special purpose processing devices such as an application specific integrated circuit (ASIC), a field programmable gate array (FPGA), a digital signal processor (DSP), a network processor, etc. The data processor 302 is configured to execute to perform steps of a method 100 and a system 200 designed for performing a trusted boot of an operating system (OS) image with a mechanism to share boot step verification functions among multiple key owners, and to perform any of the operations described above.

The computer system 300 may further include a network interface 306, a display device 312 (e.g., a liquid crystal display), an alphanumeric input device 314 (e.g., a keyboard), a cursor control device 316, and an external input device 318. In one embodiment, the display device 312, the alphanumeric input device 314, and the cursor control device 316 may be combined into a single component or device (e.g., a touch-sensitive liquid crystal display).

The stimulus receiving device 318 is one or more devices or sensors for receiving an external stimulus. A video camera, a microphone, a touch sensor, a motion sensor, a temperature sensor, a humidity sensor, a smoke sensor, a light sensor, etc. can act as a stimulus receiving device.

Storage device 308 may include a computer-readable storage medium 310 that stores instructions 330 embodying any one or more of the techniques or functions described herein (method 100). The instructions 330 may also reside wholly or at least partially in RAM 304 and/or on the data processor 302 while they are being executed by computer system 300. RAM 304 and the data processor 302 are also computer-readable storage media. In some implementations, instructions 330 may additionally be transmitted or received over network 320 via network interface device 306.

Although in the illustrative examples the computer-readable medium 310 is represented in the singular, the term “machine-readable medium” should be understood as including one or more media (for example, a centralized or distributed database and/or caches and servers) that store one or more sets of instructions. The term “machine-readable medium” should also be understood to include any medium capable of storing, encoding, or carrying a set of instructions for execution by a machine and causing the machine to perform any one or more of the techniques of the present invention. Therefore, the term “computer-readable medium” should include, but is not limited to, solid-state storage devices, optical and magnetic storage media.

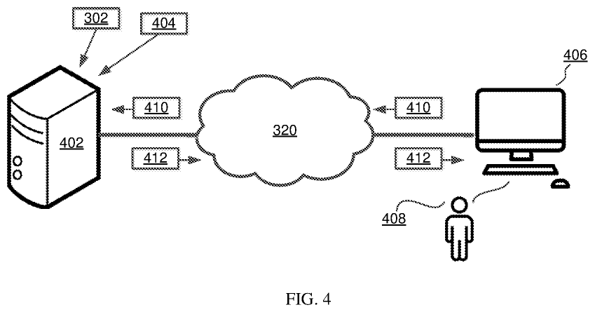

FIG. 4 depicts a server present in networked computing environment suitable for some implementations of certain non-limiting embodiments the present technology

In accordance with this broad aspect of the present technology, there is provided the server 402 for annotating video scenes in video data. The server 402 comprises processor 302 and a computer-readable medium 310 storing instructions. The processor 302, upon executing the instructions, being configured to: receive a human request 410 being a user's 408 description of a scene; process the human request 410; identify from a database 404, a video file which is relevant to the given human request, wherein the database 404 being collected upon executing following instructions: (i) acquire a video file for analysis, (ii) convert the video file into convenient for analysis format, (iii) identify video scenes by comparing adjacent video frames sequentially, said comparing is based on at least one of: a metadata, changes in the technical parameters, selecting a main keyframe for each scene from previously identified video scenes; optimize main keyframes for analysis, said optimizing comprises at least one of modification and/or compression; analyze main keyframes, comprising: (i) detection of objects appearing in the keyframes, (ii) identifying characteristics of the image respective to the keyframes, (iii) identifying logical relationships between adjacent main keyframes and interactions between detected objects; generate a metadata respective to main keyframes based on analysis, said metadata including at least one of: a text description, a structured set of labels that characterizes objects in the keyframe, a description of the object activity in the keyframes and correlations and relationships among the objects on the frames; associating generated metadata with the video file; providing to the user 408 a plurality of multimedia files 412 corresponding to the human request 410 indicating the timestamps respective to the described in the human request 410 scene.

In these embodiment, first, the server 402 can be configured to performs a full-text search in the database for the table of video scenes as described above.

In some embodiment, the server 402 can be configured to store/collect/extend database with annotated video.

In these embodiments, the server 402 can be configured to execute instructions according to method for annotating video scenes in video data as described above with reference to FIG. 1 and FIG. 2.

Further, the server 402 can be configured to transmit the plurality of multimedia files 412 to the electronic device 406 of the user 208 respective to acquired the human request 410.

In some embodiment, the server 402 can be configured to transmit as the plurality of multimedia files corresponding to the human request a plurality of video files. The user 408 receives an output with set of video files respective to the human request. In some embodiments, set of video files additionally contain the indication of the timestamps respective to the described in the human request scene. In some embodiments, user 408 can view the video fragment associated with the found frame, as well as familiarize himself with the set of annotations. In another embodiment, the user 408 receives an output with set of images of the main keyframes of the scenes and text descriptions.

Although the steps of the methods described herein are shown and described in a specific order, the order of steps of each method can be changed so that certain steps can be performed in reverse order, or so that certain steps can be performed at least partially simultaneously with other operations. In some implementations, instructions or sub-operations of individual operations may be intermittent and/or interleaved.

It should be understood that the above description is illustrative and not restrictive. Many other embodiments will become apparent to those skilled in the art upon reading and understanding the above description. Therefore, the scope of the invention is determined by reference to the appended claims as well as to the full scope of equivalents in respect of which such claims give the right to claim.

1. A method for annotating video scenes in video data, executed by at least one processor, the method comprising steps of:
receiving video data;
dividing video data into scenes sequentially, starting from the first video frame, wherein:
in response to the presence of metadata in the video data describing the sequence of scenes, dividing the scenes according to the metadata by combining the scenes with a sequence less than a predefined threshold with an adjacent scene;
in response to the absence of metadata in the video data describing the sequence of scenes:
analyzing whether the changes between adjacent video frames exceed a predefined threshold basing on comparison of video frame histograms;
analyzing whether the change in color statistics between adjacent video frames exceeds a predefined threshold basing on calculation of the mean color and color variance;
analyzing whether the result of texture analysis of adjacent video frames exceeds a predefined threshold;
in response to exceeding all said predefined thresholds, forming the position of the scene;
selecting scene keyframes for each scene, wherein
selecting start keyframe from the scene start position and end keyframe from the scene end position;
selecting intermediate keyframes between the start and end keyframes;
selecting a main keyframe for each scene from previously selected scene keyframes basing on the following parameters: mean variability per video frame pixel, contrast, color gamut;
annotating all keyframes of each scene, wherein:
generating a text description of the frame using a neural network based on the Vision Transformer architecture;
generating a structured set of labels that characterizes objects in the image;
generating a description of the object activity in scene time and changing the correlations and relationships among the objects on the scene.

2. The method according to claim 1, wherein metadata includes the start and end of the scene, the name of the scene.

3. The method according to claim 1, comprising selecting the start keyframe from the scene start position with a given offset.

4. The method according to claim 1, comprising selecting the end keyframe from the scene end position with a given offset.

5. The method according to claim 1, comprising selecting dynamically intermediate keyframes basing on available computing resources.

6. A system for annotating video scenes in video data, comprising:
the processor, upon executing the instructions, being configured to:
receiving video data;
dividing video data into scenes sequentially, starting from the first video frame, wherein:
in response to the presence of metadata in the video data describing the sequence of scenes, dividing the scenes according to the metadata by combining the scenes with a sequence less than a predefined threshold with an adjacent scene;
in response to the absence of metadata in the video data describing the sequence of scenes:
analyzing whether the changes between adjacent video frames exceed a predefined threshold basing on comparison of video frame histograms;
analyzing whether the change in color statistics between adjacent video frames exceeds a predefined threshold basing on calculation of the mean color and color variance;
analyzing whether the result of texture analysis of adjacent video frames exceeds a predefined threshold;
in response to exceeding all said predefined thresholds, forming the position of the scene;
selecting scene keyframes for each scene, wherein:
selecting start keyframe from the scene start position and end keyframe from the scene end position;
selecting intermediate keyframes between the start and end keyframes;
selecting a main keyframe for each scene from previously selected scene keyframes basing on the following parameters: mean variability per video frame pixel, contrast, color gamut;
annotating all keyframes of each scene, wherein:
generating a text description of the frame using a neural network based on the Vision Transformer architecture;
generating a structured set of labels that characterizes objects in the image;
generating a description of the object activity in scene time and changing the correlations and relationships among the objects on the scene.

7. The system according to claim 6, wherein metadata includes the start and end of the scene, the name of the scene.

8. The system according to claim 6, comprising selecting the start keyframe from the scene start position with a given offset.

9. The system according to claim 6, comprising selecting the end keyframe from the scene end position with a given offset.

10. The system according to claim 6, comprising selecting dynamically intermediate keyframes basing on available computing resources.

11. A server for annotating video scenes in video data, the server comprises a processor and a computer-readable medium storing instructions, the processor being configured to executing the following instructions:
receiving a human request being a user's description of a scene;
processing the human request;
identifying from a database, a video file which is relevant to the given human request, wherein the database being collected upon executing following instructions:
acquiring a video file for analysis;
converting the video file into convenient for analysis format;
identifying video scenes by comparing adjacent video frames sequentially, said comparing is based on at least one of:
a metadata;
changes in the technical parameters;
selecting a main keyframe for each scene from previously identified video scenes;
optimizing main keyframes for analysis, said optimizing comprises at least one of modification and/or compression;
analyzing main keyframes, comprising:
detection of objects appearing in the keyframes;
identifying characteristics of the image respective to the keyframes;
identifying logical relationships between adjacent main keyframes and interactions between detected objects;
generating a metadata respective to main keyframes based on analysis, said metadata including at least one of:
a text description;
a structured set of labels that characterizes objects in the keyframe;
a description of the object activity in the keyframes and correlations and relationships among the objects on the frames;
associating generated metadata with the video file;
providing to the user a plurality of multimedia files corresponding to the human request respective to the described in the human request scene.

12. The server according to claim 11, wherein to analyze main keyframes, the processor is further configured to apply at least one neural network.

13. The server according to claim 11, wherein to process the human request, the processor is further configured to apply at least one natural language processing algorithm.

14. The server according to claim 11, wherein the plurality of multimedia files corresponding to the human request is a plurality of video files or a plurality of images of the main keyframes of the scenes.

15. The server according to claim 14, wherein the plurality of multimedia files corresponding to the human request comprises a text descriptions.
